(19) United States
(12) Patent Application Publication
(10) Pub. No.: US 2007/0034694 A1
(43) Pub. Date: Feb. 15, 2007

(54) Interactive display system with indicia reader

(75) Inventors: Gary S. Jensen, Drexel Hill, PA (US); Lath B. Carlson, Jim Thorpe, PA (US); Paul F. Schmidt, Lansdale, PA (US)

Correspondence Address: SYNNESTVEDT & LECHNER, LLP, 2600 ARAMARK TOWER, 1101 MARKET STREET, PHILADELPHIA, PA, 191072950, US

(73) Assignee: Dublin Management Associates of New Jersey, Inc., Burlington, NJ (US)

(21) Appl. No.: 11/340,218

(22) Filed: Jan. 26, 2006

Related U.S. Application Data
(60) Provisional application No. 60/647,063, filed on Jan. 26, 2005.

(51) Int. Cl. G06K 7/00; G06F 17/00

(52) U.S. Cl. 235/439; 235/375

(57) ABSTRACT

An interactive display capable of providing an interested party with information relating to an object. The object is provided with identifying indicia. The display includes a reader for reading the indicia. Identifying information read from the indicia for a particular object is used to retrieve object information stored in memory in associating with the identifying information for the object. A display system includes the interactive display and a rack supporting multiple objects, each of which is provided with unique identifying indicia capable of being read by the indicia reader of the interactive display. The interactive display displays object information retrieved from the memory to the interested party when the object's identifying indicia is read by the interactive display's indicia reader. The system is particularly useful for displaying product information relating to specially configured product samples supported in a conventional display rack.

### CROSS-REFERENCE TO RELATED APPLICATION

This application claims the benefit of U.S. Provisional Patent Application No. 60/647,063, filed Jan. 26, 2005, the entire disclosure of which is hereby incorporated herein by reference

### FIELD OF THE INVENTION

The present invention relates generally to display devices of a type often used in retail, commercial, trade show and similar environments.

### DISCUSSION OF THE RELATED ART

Many products sold in commerce are displayed to potential consumers or others using product samples. Some product samples are miniaturized versions of an actual product. Other product samples are individual units of the actual product. Yet other product samples are full-size pieces of only a small portion of an actual product. Flooring products are one example of products often displayed using this latter type of product sample. Exemplary flooring products include carpeting, ceramic tiles, hardwood floors, modular laminate composition floors, and vinyl or other sheet flooring goods. Such products typically have a visually repeating pattern. Product samples used in retail, wholesale, trade show or other displays are typically relatively small in size (e.g. less than four square feet in area) so as to be easily manageable, and to facilitate storage and display of multiple different patterns, colors, textures, or other options in a relatively small amount of display space. By way of example, such product samples are often displayed for sale on shelves, racks, or pivotably mounted frames. Bricks, paving stones, flagstones, fabrics, paint color samples, countertop surfacing products, kitchen cabinets, shades, blinds, and the like are often displayed in similar displays and/or in a similar sample-based manner.

Typically, the product samples are removable from such conventional displays for closer inspection by a buyer or other interested party (“interested party”). However, such closer inspection is often unsuitable or inadequate in assisting an interested party in fully appreciating and/or visualizing the product in its intended actual form (e.g., on a kitchen floor measuring 12 feet by 22 feet), or in a setting similar thereto (e.g., a room-sized environment).

Some flooring manufacturers have adopted the use of interactive, computer-based, multi-media displays to assist potential customers. For example, Mannington Mills, Inc. of Salem, N.J. has developed a website at Mannington.com having a Floor Finder feature that allows a computer user to use a keyboard and/or mouse to provide typed and/or selected input for a product name, product number or product characteristics as search terms to identify and view on the web site a color image of a small portion (e.g. an image of a 2 foot square) of a selected flooring product. However, this requires that the interested party have or have access to a computer and network connection, and further requires the interested party to have and/or use typing, clicking, and/or other computer skills, which can be particularly undesirable, time consuming, intimidating and/or unwelcoming for some individuals. Further, this system fails to provide the interested party with an aid for visualizing the product in a form greater than the product sample.

### SUMMARY

The present invention provides an interactive display capable of providing an interested party with a visual aid for visualizing a product in a form greater than the product sample, namely an image of the product in a form greater than that of the product sample, e.g. larger in size, including a greater portion and/or number of repeating pattern elements, as installed in an actual room, or displayed in another appropriate visual context. Further, the display permits an interested party to interact with the display to obtain such a visual aid without any need for his/her own computer or network connection, and without the need for any computer skills.

The interactive display is preferably provided in free-standing kiosk form that includes computerized and other hardware for reading RFID tags, bar codes, or similar identifying indicia. A display system including an inventive display kiosk may further include a conventional product sample rack for displaying multiple different product samples, each of which is provided with a respective RFID tag, bar code or similar indicia that can be read by the kiosk, so that the kiosk may retrieve from a computerized database image, text or other information stored in memory in association with an identification code read from the RFID tag, bar code or similar indicia, and display such information on a video display screen, etc.

### BRIEF DESCRIPTION OF THE DRAWINGS

The present invention will now be described by way of example with reference to the following drawings in which:

FIG. 1 is a perspective view of an exemplary free-standing display kiosk in accordance with the present invention;

FIGS. 2, 3 and 4 are perspective views of exemplary conventional product sample racks of a type generally known in the art, the displays supporting product samples configured in accordance with the present invention;

FIG. 5 is a block diagram of an exemplary PC in accordance with the present invention;

FIG. 6 is another perspective view of the exemplary display kiosk of FIG. 1;

FIG. 7 is a rearview of the exemplary display kiosk of FIG. 1; and

FIG. 8 is a flow diagram illustrating exemplary operation of the display kiosk of FIG. 1.

### DETAILED DESCRIPTION

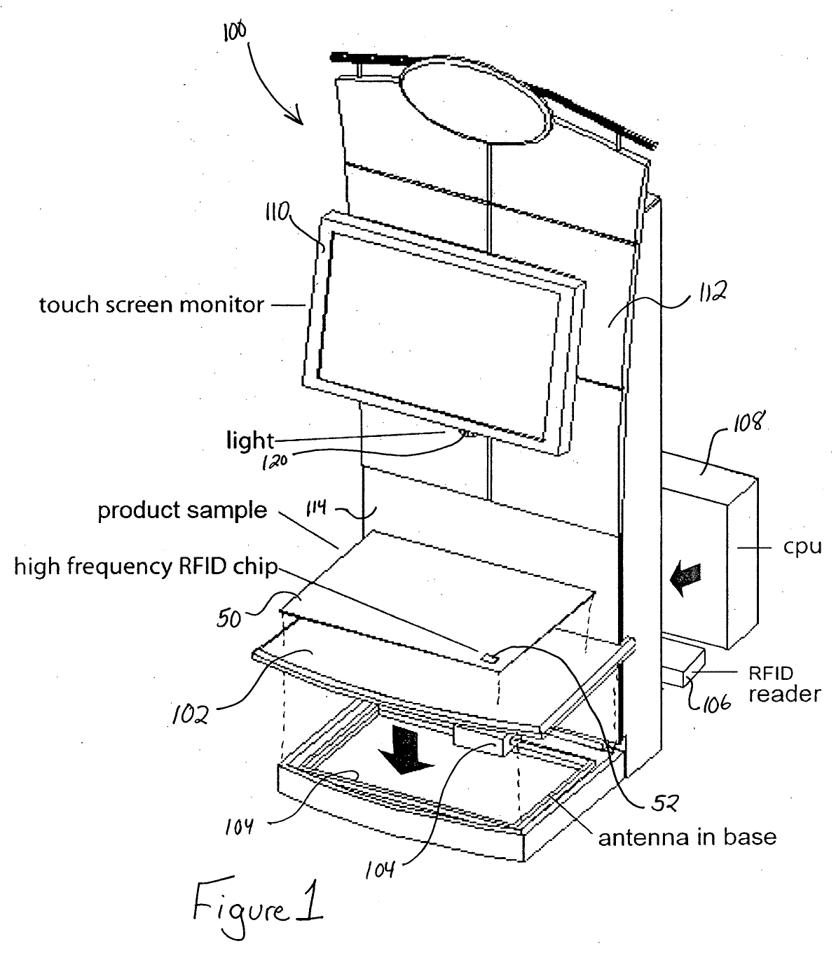

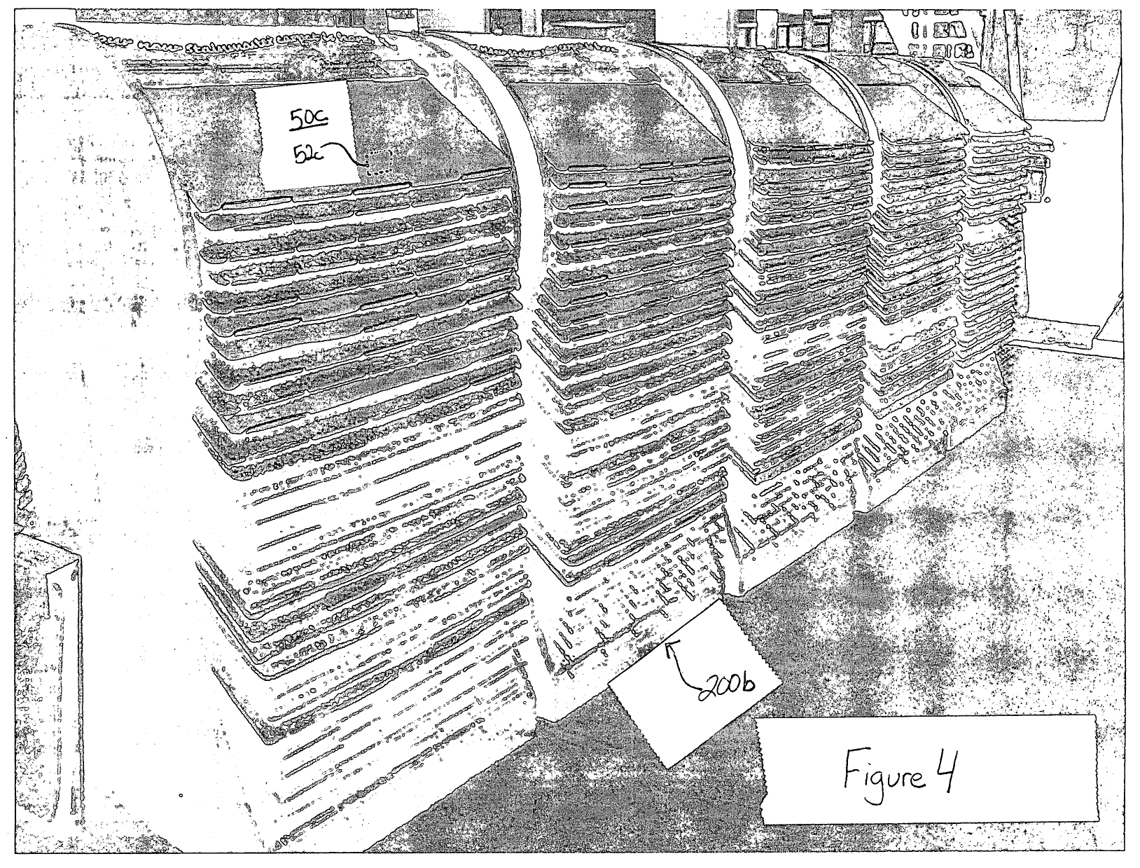

Referring now to FIGS. 1-3, the present invention provides a novel, specially configured interactive display 100 (FIG. 1) that includes electronic hardware and/or software capable of reading information identifying a physical object, such as a product sample, in automated fashion from an identifying indicia provided on the object, e.g. via a separate identification tag attached to the object. The interactive display 100 is further configured to use the information read from the product sample, etc. to retrieve product or related information from a computerized database. Such information may include image, text or other information stored in memory in association with the information read from the identification. The interactive display 100 is further configured to display/present such information on a video display screen, speakers, etc. Accordingly, a shopper, without a PC or sophisticated electronics, may physically remove a specially configured product sample from a conventional display rack, bring it to the interactive display, and have information about the product displayed to the shopper. This arrangement is particularly useful in trade show, retail and wholesale environments.

In a preferred embodiment, the identification tag includes a radio frequency identification (RFID) tag attached to the product sample. However, the identification tag may have various forms, and any suitable form may be used. For example, the identification tag may include a bar code, and the kiosk may be configured with an optical bar code scanner, etc. for reading information from bar codes. Alternatively, the identification tag may have textual indicia, and the interactive display may be configured with an optical scanner and optical character recognition software, etc. For illustrative purposes only, the present invention is discussed below in the context of an RFID-based system for use with product samples in a commercial environment.

Referring again to FIG. 1, the exemplary interactive display 100 includes a platform 102 for supporting a specially configured product sample 50. The platform 102 is preferably mounted to a housing of the display 100 in a substantially horizontal orientation to facilitate supporting of a product sample. The product sample 50 is specially configured in accordance with the present invention to include attached thereto an identification tag, such as a conventional RFID tag 52. Such RFID tags are well known in the art in any suitable RFID tag may be used. In accordance with the present invention, the RFID tag 52 is selected and/or configured to be: (1) compatible with an RFID interrogator of the display 100; and (2) carrying information for, or otherwise being capable of, identifying the attached product sample.

In general, a conventional RFID tag functions in response to a coded RF signal received from a base station/interrogator. Typically, the tag reflects the incident RF carrier back to the interrogator. Information is transferred back to the interrogator as the reflected signal is modulated by the tag according to its programmed information protocol.

A typical tag consists of a semiconductor chip having RF circuits, logic, and memory. The tag also has an antenna, often a collection of discrete components, such as capacitors and diodes for example, a battery in the case of active tags, a substrate for mounting the components, interconnections between components, and a means of physical enclosure. One variety of tag, passive tags, has no battery. Instead, passive tags derive their energy from the RF signal used to interrogate the tag. Accordingly, the RFID tag is part of an RFID system that includes a reader/interrogator (“interrogator”) that is capable of detecting when the RFID tag is within a physical location (“zone”) monitored by the interrogator, and of identifying the tag and/or receiving identifying information carried by the tag.

These and other arrangements are described in greater detail in U.S. Pat. No. 5,528,222 to Moskowitz et al. and U.S. Pat. No. 6,693,539 to Bowers et al., the entire disclosures of both of which are hereby incorporated herein by reference. Any other suitable RFID tag may be used, provided that the RFID tag is capable of identifying the product sample to which it is attached. By way of specific example, suitable RFID antenna, power supply, passive RFID tags and RFID interrogator components manufactured by Texas Instruments, Inc. are commercially available from Dynasys International of Pawcatuck, Conn.

In addition to the platform 102, the display 100 preferably includes a personal computer (PC) 108 having hardware and software that are substantially conventional in nature. The PC 108 includes data storage (such as a hard disk drive) and is operably connected to a video display device 110 for displaying text/images retrieved into a form from the hard disk drive, as discussed in greater detail below. Preferably, the display 100 includes an upright member 112 extending upwardly from the platform 102 to support the video display device 110 in a substantially upright orientation, and at substantially eye-level for an adult human. A conventional CRT or LCD computer monitor is suitable for this purpose. In certain embodiments, the display 100 is provided with additional interactive capability, and a conventional touch screen monitor is employed as the video display device 110, as discussed in greater detail below.

The exemplary display 100 further includes an RFID system antenna 104 positioned adjacent the platform 102 so as to establish a zone in which an RFID tag can be read. The RFID system is positioned and/or tuned to ensure that the zone is established for reading an RFID tag when it is positioned on or very near the platform 102. An RFID tag interrogator 106 is operably connected to the antenna 104. The RFID tag interrogator 106 is further operably connected to the PC 108, e.g. via a conventional I/O board (e.g., serial), for reading RFID tags and communicating information received from an RFID tag to conventional RFID software stored and/or running on the PC 108.

Accordingly, the display 100 provides that any compatible RFID tag 52 placed on or very near the platform 102 will result in the interrogator's 106 interrogation of that tag 52, and communication of information uniquely identifying that RFID tag 52 to the PC 108.

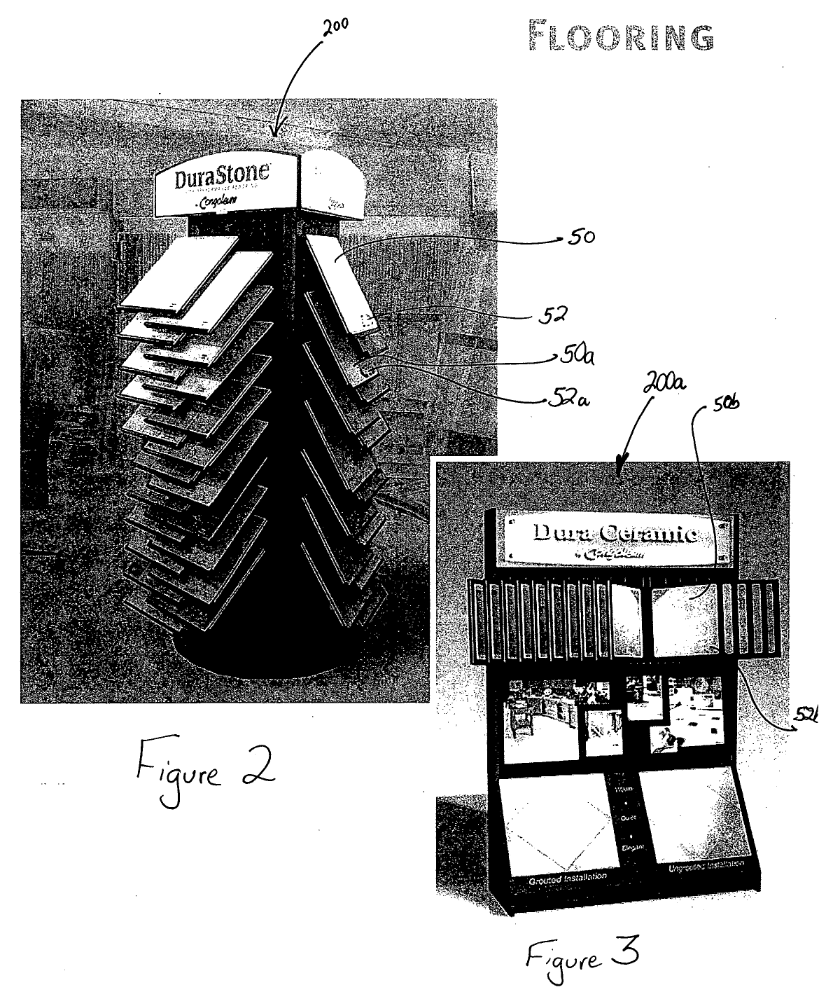

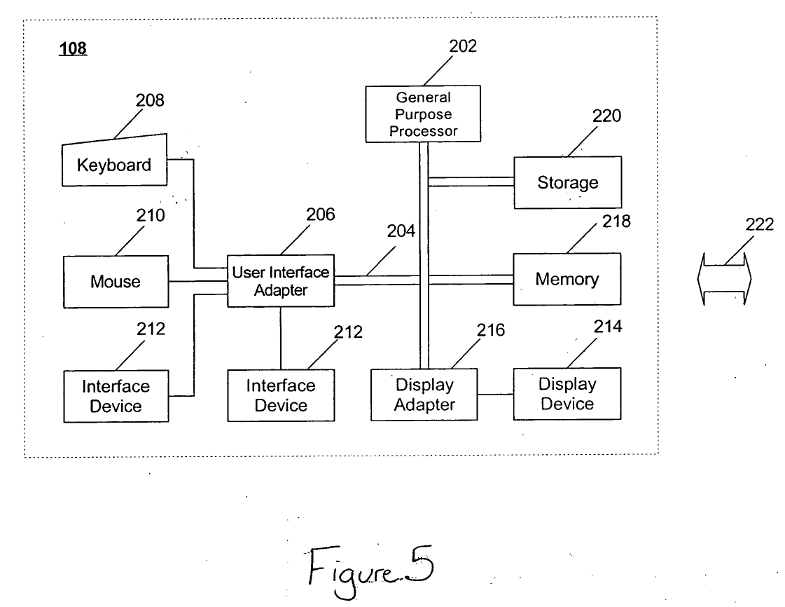

As shown in FIGS. 2, 3 and 4, in accordance with the present invention, each product sample (50, 50a, 50b, 50c, etc.) of an associated product sample rack 200, 200a, 200b is provided with its own respective identification tag that is compatible with the reader provided in the display 100, in this case an RFID tag (52, 52a, 52b, 52c, etc.). Each identification tag is configured to uniquely identify a corresponding product sample, much like a conventional UPC code. Each RFID tag may be configured to provide a unique code as known in the art. For example, each tag may be adhered to the bottom side of a respective product sample. For example, an eighteen inch square sample of Mannington® New Brighton pattern, Desert Sand color, resilient vinyl flooring, manufactured and/or distributed by Mannington Mills, Inc. of Salem, N.J., may be provided with an RFID tag storing a unique code 123456789 that is received/recognized by the PC 108 upon interrogation of the RFID tag. Accordingly, when that sample is placed on the platform, the PC 108 recognizes the product sample as Mannington® New Brighton pattern, Desert Sand color, resilient vinyl flooring, e.g. by cross-referencing the code 123456789 read from the RFID tag with product information stored in association with that code in a memory of, or accessible to, the PC. More specifically, the RFID reader and antenna may continually or repeatedly transmit a signal to the zone to detect any RFID tags within the zone, and to identify information carried by the tag positioned therein, that information being used by the PC to identify the product sample and any related information stored by the PC 108, as discussed in greater detail below

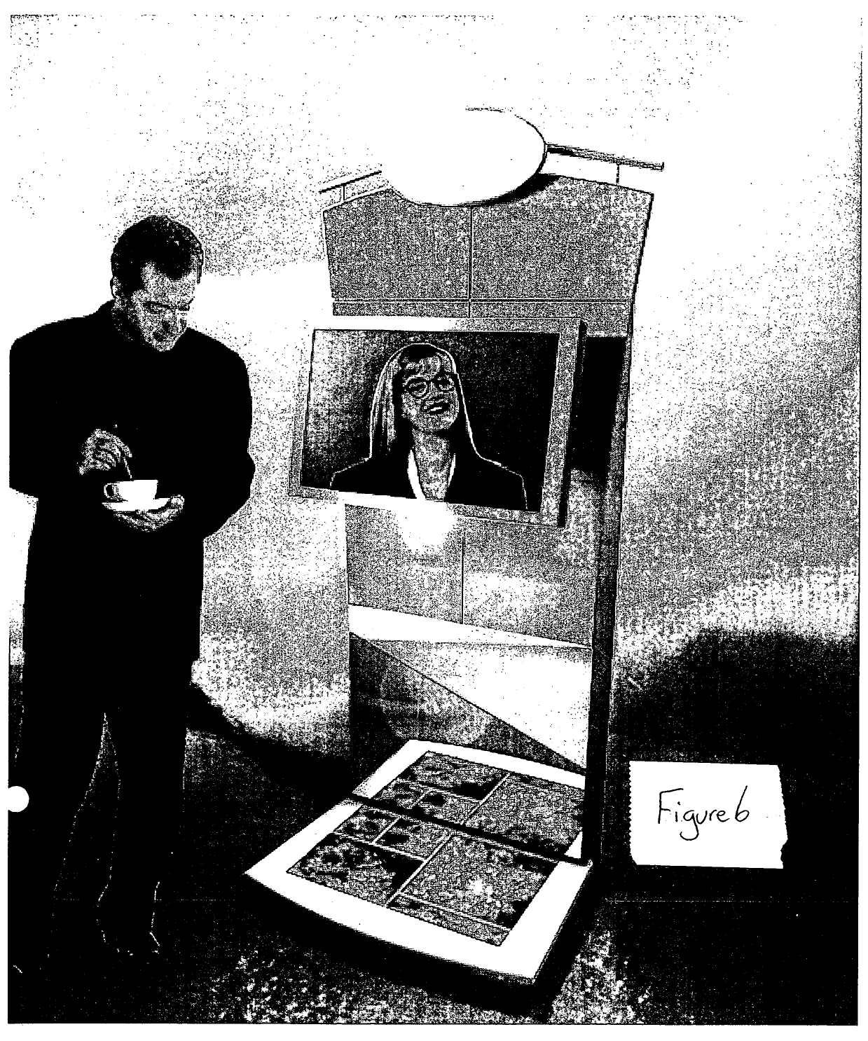

As described above, the PC 108 is largely conventional in nature in that in includes primarily conventional hardware and software. Accordingly, as shown in FIG. 5, the PC 108 includes a general purpose microprocessor (CPU) 202 and a bus 204 employed to connect and enable communication between the microprocessor 202 and the components of PC 108 in accordance with known techniques. The PC 108 includes a user interface adapter 206, which connects the microprocessor 202 via the bus 204 to one or more interface devices, such as a keyboard 208, mouse 210, and/or other interface devices 212, which can be any user interface device, such as a touch sensitive screen, digitized entry pad, etc. The bus 204 also connects a display device 214, such as an LCD screen or monitor, or a touch sensitive screen, to the microprocessor 202 via a display adapter 216. The bus 204 also connects the microprocessor 202 to memory 218 and long-term storage 220 (collectively, “memory”) which can include a hard drive, diskette drive, tape drive, etc.

The PC 108 may communicate with other computers or networks of computers, for example via a communications channel, network card or modem 222. The PC 108 may be associated with such other computers in a local area network (LAN) or a wide area network (WAN), or the PC 108 can be a client or server in a client/server arrangement with another computer, etc. All of these configurations, as well as the appropriate communications hardware and software, are known in the art.

Software programming code for carrying out the techniques described herein is stored in memory. Accordingly, the PC 108 stores in its memory microprocessor executable instructions. These instructions include programs for carrying out the techniques describes herein.

Further, the exemplary PC 108 stores in its memory 218/220, a database of information in accordance with the present invention. Alternatively, all or a portion of the database is stored remotely, e.g. on a remote server that is accessible via a communications network. In particular, the database includes at least (1) information corresponding to the information carried by the RFID tags, e.g. a product sample identification code such as 123456789 as used in the example above, and (2) information, such as text and images, associated with such information. For example, in association with product sample identification code 123456789, the database may store a photographic image of a kitchen having installed therein the flooring product identified by product sample identification code 123456789.

In such an example, the PC 108 is configured with specifically configured software in accordance with the present invention to (1) identify the information carried by an RFID tag detected within the monitored zone, (2) reference the database of the PC (or elsewhere) to identify stored data associated with the information carried by the RFID tag, and (3) retrieve and display at least a portion of the stored data on the video display device 110 of the display 100. The device may be configured to terminate the display on the video display device 110 after the RFID tag is no longer present in the zone.

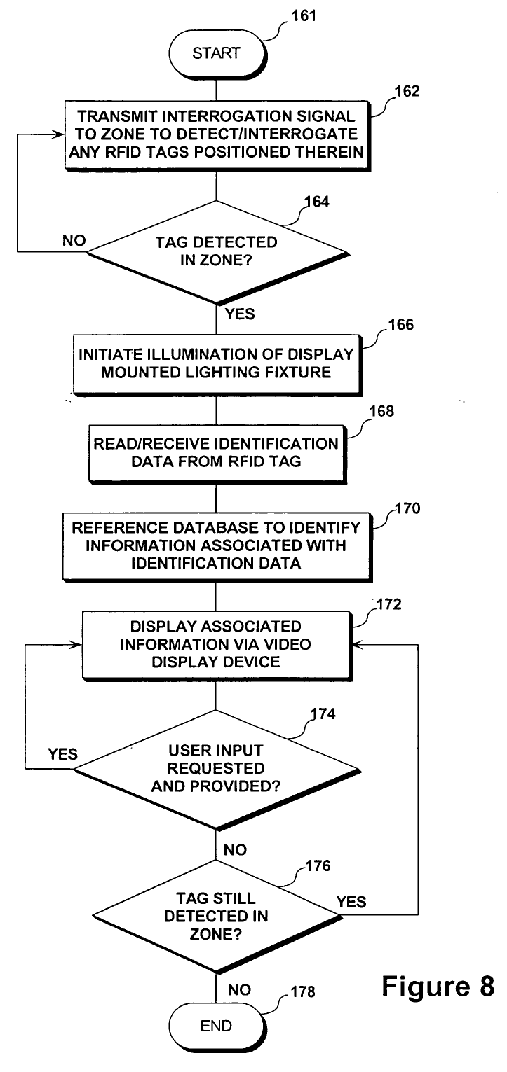

FIG. 8 is a flow diagram 160 illustrating an exemplary method of operation of the display of FIG. 1 in accordance with the present invention. Referring now to FIG. 8, the exemplary method begins with transmission of an interrogation signal to the zone. The zone includes space that will be occupied by an RFID tag borne by a sample resting on the platform 102. The signal is transmitted from via the antenna 104 of the interactive display 100. The transmission of this signal allows the interactive display to detect any RFID tags positioned within the zone.

If no tags are positioned within the zone, the signal may be retransmitted, e.g. after a predefined delay period and/or substantially continuously. This continues until an RFID tag is detected within the zone, as shown at steps 162 and 164.

If an RFID tag is detected within the zone, then the display initiates illumination of the lighting fixture 120 of the display, as shown at 166. This may be achieved by selectively directing an electrical power signal to the lighting fixture, e.g. under control of the PC 108, as discussed above. This provides a proximity sensing function that is designed to attract users and/or enhance a user's experience, as well as provide additional lighting of the product sample of interest, which will be positioned on the platform in the illuminated area.

The interactive display reads and/or receives identification data from the RFID tag, as discussed above, as shown at step 168. This data is received and/or read by a conventional RFID reader 106. The identification data allows for unique identification of the product sample associated with the RFID tag, e.g., by cross-referencing identification data received from the RFID tag with data stored in a database/memory of the PC 108. Accordingly, information associated with the identification data is retrieved from the database, as shown at step 170.

At least a portion of the associated information is then displayed via the video display device 110 of the interactive display 100, as shown at step 172. For example, an mpeg format movie file may be retrieved from the database and be displayed via the video display device 110. It will be appreciated that non-video information such as audio signals, lighting effects, photographs/images, etc. may similarly be presented to the user via the video display device 110 or speakers, lighting, etc.

In this embodiment, user input is requested as shown at step 174, e.g. via a video display monitor 110 configured as a touch screen. If user input is requested and provided, the system may responsively display associated information, e.g., by retrieving additional information from a database of the PC 108, as shown at steps 172 and 174.

If user input is not provided, or is neither requested nor provided, then the interactive display determined whether the tag is still detected within the zone, as shown at steps 174 and 176. If it is, then the interactive display 100 continues to display the associated information, as shown at steps 176 and 172. If not, then the system stops displaying the associated information, as shown at steps 176 and 178, Accordingly, the system stops displaying information when the sample is removed from the interactive display, since it is determined that the product sample is no longer being considered by a potential buyer, etc. The system is then ready for use by a subsequent potential buyer, etc.

It will be appreciated that this provides a particularly user-friendly display of information, without the need for an interested party to operate a PC in a conventional manner, or to have or use conventional computer skills. Instead, an interested party may simply remove a selected product sample from a conventional display rack, place it on the platform 102 or otherwise near the interactive display 100, and be shown related information on the video display device 110.

It will be appreciated that in alternative embodiments, software may be provided on the PC 108 to render a computer generated image showing the selected product sample, e.g. the corresponding flooring, rather than a photographic image.

Optionally, the display 100 may be further configured with a conventional proximity sensor that detects a person or identification code in proximity to the display and triggers an effect, such as additional lighting, music, producing an audio signal conveying a welcome message, etc. In this manner, a potential user of the display is enticed to operate the display to obtain product information, etc.

In one embodiment, each product sample is a single unit of area (e.g., to include a single unit of a repeating pattern), and the information displayed via the video display device includes a plurality of juxtaposed units of area/the repeating pattern. For example, the product sample may be a 12 inch ceramic tile square of a particular color and pattern, and the displayed information may include an image of 64 juxtaposed product samples/tiles to simulate a square floor that measures 8 feet in length and 8 feet in width.

Further, the displayed information preferably includes environmental image information in addition to a product image. For example, the displayed information may be an image depicting kitchen cabinets, a kitchen table and the like to help visualize the selected ceramic tile floor in a kitchen environment.

Additionally, other information may be provided, such as text, video clips, audio clips, and the like. This other information may depict the product associated with the product sample, or, may simply provide information related to interest in the product associated with the product sample such as contractor services, coupons, promotions, other products of possible interest, and the like.

Optionally, a printer may be provided and printed information may be automatically generated for the interested party under the direction of suitably configured software on the PC 108.

A display system in accordance with the present invention optionally includes a conventional display for supporting a plurality of different product samples, a plurality of product samples stored/storable in the conventional display, each product sample having attached thereto an RFID tag uniquely identifying the corresponding product sample, and a display including an RFID interrogator and a video display device, as described above. Preferably, all elements of the display system described above are provided in a common physical location, e.g. within a single retail store or other building.

It will be appreciated that a single interactive display 100 may be configured to be compatible with similar or competing products of multiple different manufacturers. For example, a The Home Depot building supply store may have a single display device that is capable of displaying information relating to Mannington's vinyl flooring and Congoleum's vinyl flooring. Further, a single display device may be configured to support dissimilar products. For example, a The Home Depot building supply store may have a single display device that is capable of displaying information relating to flooring samples and kitchen cabinets.

In a certain embodiment, the display device includes reporting functionality. In such an embodiment, a record is maintained of the product samples for which the corresponding RFID tag information has been read, e.g. by storing such data in the memory of the PC 108. In this manner, the retailer, product manufacturer, operator of the display device, or other party obtains information as to the levels of interest for the products in the corresponding displays. This can be useful, for example, in determining whether to discontinue a particular product, to gauge the success of a newly introduced product, and the like. For example, frequent reading of an RFID tag of a particular product sample may be interpreted as a high level of interest in the corresponding product, whereas infrequent reading of an RFID tag of another product sample may be interpreted as a low level of interest in the corresponding product.

In one embodiment, such data is stored locally in the memory of the PC 108 and later copied to a portable storage medium such as a floppy disk, CD-RW, jump drive, or the like. Alternatively, such information may be displayed in textual or graphical form by producing a printout from the PC or by displaying such information via a secondary video display monitor 150 viewable from the rear of the display 100, shown in FIG. 7. In another embodiment, such data is temporarily stored in the memory of the PC 108 and transmitted via the PC's network connection to other computers/computer networks. In yet another embodiment, such data is immediately transmitted to other computers/computer networks without storage in the PC's memory.

Optionally, data is gathered from multiple display devices at a central location, and aggregated statistics are compiled. For example, data may be gathered to determine the number of times a particular product has been viewed via displays 100 at all The Home Depot stores, on one particular day.

In a certain embodiment, notices may be sent to the manufacturer, the retailer, or the operator of the display 100. When a product sample is scanned that has been flagged as discontinued in the database of the PC 108. This notice may alert manufacturer/retailer to continued interest in the discontinued products sample, or, may be used to provide structured and to the retailer/display operator to remove the discontinued product sample from the set of samples maintained in the conventional display 200.

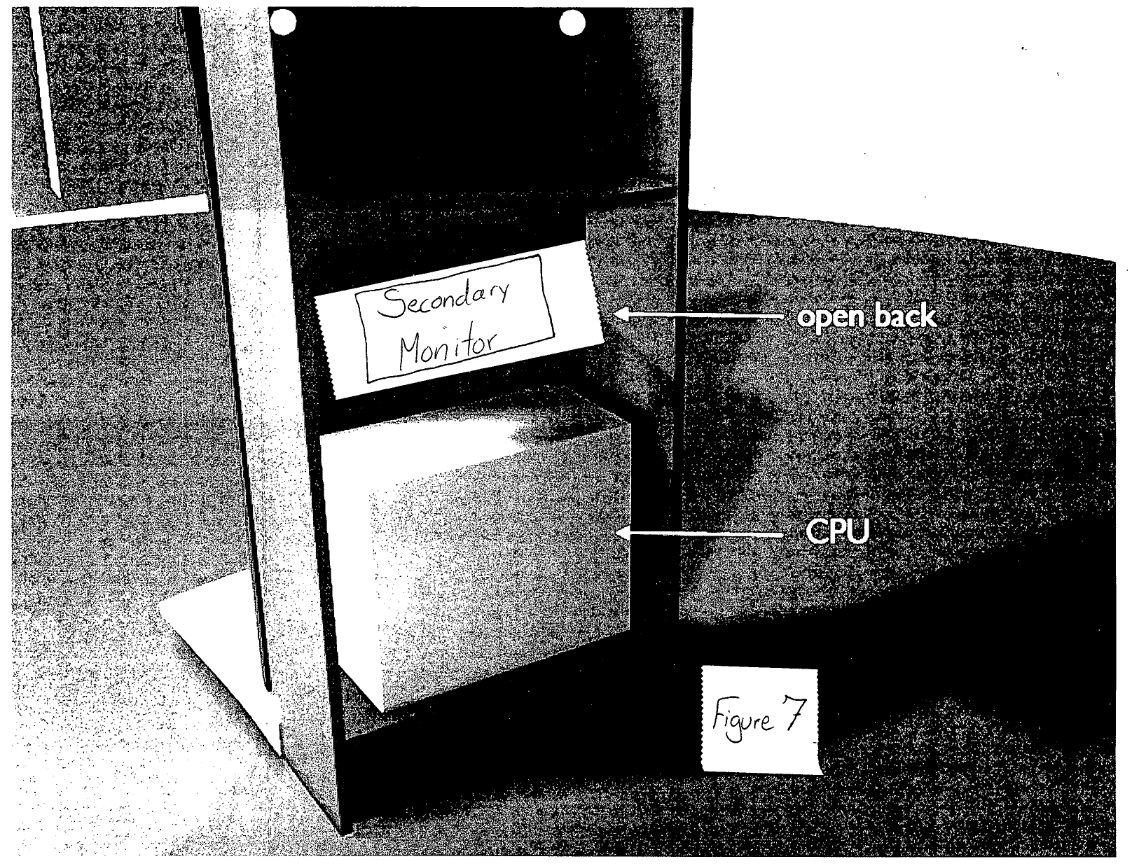

In one embodiment, the display 100 also includes an electric lighting fixture 120 mounted to the upright member 112 in a position to illuminate the top surface of the product sample 50 positioned on the platform 102, has been shown in FIGS. 1 and 6. Optionally, operation of the electric lighting fixture 120 is controlled by the PC 108 to cause the light to be illuminated only in response to detection of an RFID tag 52 within the zone monitored by the interrogator 106. Accordingly, the PC 108 extinguishes the lighting fixture 120 after an RFID tag 52 is no longer detected within the zone.

In a preferred embodiment, the upright member 112 is provided with a mirror 114 that is substantially perpendicular to the platform 102, shown in FIGS. 1 and 6. In this manner, a substantially flat product sample 50 will appear twice as large as the actual sample 52 when the edge of the sample 50 is abutting the mirror 114 due to the reflection in the mirror, as best shown in FIG. 6.

In a particular embodiment, the display 100 is enhanced to provide an additional interactive functionality. In such an embodiment, the PC 108 is provided with additional software for displaying additional information via the video display screen 110. For example, user input may be requested to select an environment in which to display the product sample, e.g., a kitchen, a bathroom, a laundry room, a family room, or the like. In one such embodiment, the video display screen 110 is a conventional touchscreen monitor capable of accepting input from a person touching the monitor's screen. Alternatively, a keyboard, mouse, stylus, or other input device may be provided for this purpose. Optionally, the software may propose a suggested room environment, room wall paint color, or the like, for the interested party's approval before displaying information via the video display device 110. Options may be provided to display a select a product in alternative settings e.g. in a bathroom when a kitchen is shown.

Optionally, the software may be configured to permit interested party to save information from their session, e.g. by displaying on the video display device the text “Save? Touch YES or NO.” Further, the interested party may be permitted to enter his/her e-mail address by selecting key buttons via a keyboard displayed on the touchscreen, and the PC 108 and composes an e-mail including pertinent information from this session, e.g. products, manufacturers' names, product names, colors, styles, model numbers, prices, retail stores where the products are available, manufacturers' contact information, or the like.

It will be appreciated that although the description above is presented in the context of a display of salable products, the display device and system is also applicable to a wide variety of physical objects that are not “product samples”. For example, in additional to use for commercial purposes, the display could also be used as an informational or educational tool to convey information relating to objects that are not for sale. For example, a set of different miniature farm animal figurine objects could be provided with their own respective RFID tags, e.g. to identify a particular object as a pig, for example. Additionally, the database may associate the pig object's RFID tag with corresponding English-language text (“pig”), French language text (“cochon”) and Spanish language text (“cerdo”), as well as audio files including reproducible sound clips of a person speaking each of the words in each of the languages. This can help teach an English-speaking person foreign language terms. Alternatively, a number of different objects could be distributed as a kit. Alternatively, a museum display could be provided with a sword replica, a cannon replica, a flag replica or other objects, each having their own unique RFID tag that would initiate display via the display device of corresponding information via the video display. For example, placing a miniature crate labeled “TEA” on the platform might initiate display of a video clip describing the Boston Tea Party/U.S. Revolutionary War event of 1773. It will be appreciated that the pig and crate objects need not be for sale and may not be product samples in the strict sense of the term, but the corresponding device and system are nevertheless within the scope of the present invention described herein.

It should also be noted that some products, such as some medications, and some retail products, are already equipped with RFID tags used for inventory control and tracking purposes. It will be understood that it is within the scope of the present invention to provide a display capable of reading such RFID tags from the actual products themselves as a trigger for displaying related information via a video display device of the display.

It should also be noted that it is within the scope of the present invention to use as an alternative to RFID tags and related RFID interrogation hardware/software, conventional bar codes and bar-code scanners of the type commonly found and were used in most retail store environments. In such an embodiment, the RFID related hardware or software may optionally be omitted, and the display is provided instead within optical and bar-code scanner capable of reading and bar-code attached to a product or product sample placed all in or near the bar-code scanner of the display. Straightforward modifications to the system to provide for obtaining of identifying information via bar codes may be required, as will be appreciated by those skilled in the art.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting.

What is claimed is:

1. An interactive display for providing information relating to a physical object system, the interactive display comprising:
a housing;
a video display device supported on said housing;
an RFID tag reader supported on said housing, said RFID tag reader being configured to read an RFID tag when positioned within a zone adjacent the housing;
a computerized system configured to receive object identification information from said RFID tag reader when said RFID tag is positioned within the zone and to provide related object information on said video display device; said computerized system comprising:
a microprocessor;
a memory operably connected to said microprocessor; and
related object information stored in said memory, the related object information being stored in said memory in association with the object identification information.

2. The interactive display of claim 1, wherein said computerized system is further configured to stop displaying any related object information when said RFID tag is removed from the zone.

3. The interactive display of claim 1, further comprising:
a substantially flat platform for supporting the object, said platform being supported substantially horizontally on said housing.

4. The interactive display of claim 3, further comprising:
a mirror for providing a reflected image of the object, said mirror being supported on said housing in a substantially vertical position adjacent said platform.

5. The interactive display of claim 3, further comprising;
a lighting fixture mounted on said housing in position to direct light downwardly onto said platform, said lighting fixture being configured to change from an extinguished state to an illuminated state responsive entry of an RFID tag into the zone.

6. The interactive display of claim 1, wherein said RFID tag reader comprises:
an RFID interrogator for generating a RFID interrogation signal; and
an RFID antenna for transmitting the RFID interrogation signal and receiving a reflected RF carrier signal from the RFID tag.

7. The interactive display of claim 1, wherein the memory of the computerized system is housed within the housing.

8. The interactive display of claim 1, wherein the memory of the computerized system is housed remotely from the housing and is accessible to the microprocessor via a communications network.

9. The interactive display of claim 1, wherein each object comprises a product sample having an area of a single unit, and wherein the related object information displayed via the video display device comprises an image of a plurality of juxtaposed units of area.

10. The interactive display of claim 1, wherein the related object information comprises audible information reproduced as an audible signal.

11. The interactive display of claim 1, wherein the computerized system comprises a network communications device, the computerized system being configured to transmit via a communications network information identifying RFID tags that have been read.

12. The interactive display of claim 1, wherein said housing is configured in free-standing kiosk form.

13. A display system comprising:
an interactive display for providing information relating to a physical object system, the interactive display comprising:
a housing;
a video display device supported on said housing;
an indicia reader supported on said housing, said indicia reader being configured to read an indicia-bearing tag when positioned within a zone adjacent the housing;
a computerized system configured to receive object identification information from said indicia reader when said indicia-bearing tag is positioned within the zone and to provide related object information on said video display device; said computerized system comprising:
a microprocessor;
a memory operably connected to said microprocessor; and
related object information stored in said memory, the related object information being stored in said memory in association with the object identification information; and
a rack for supporting a plurality of different physical objects, each of said plurality of different physical objects being selectively removable from and replaceable on said rack.

14. The display system of claim 13, further comprising:
a plurality of different physical objects, each of said plurality of different physical objects being provided with a respective indicia-bearing tag capable of uniquely identifying each of said plurality of different physical objects.

15. The display system of claim 13, wherein said indicia-bearing tag comprises an RFID tab, and wherein said indicia reader comprises and RFID tag reader.

16. The display system of claim 13, wherein said indicia-bearing tag comprises a bar code, and wherein said indicia reader comprises an optical bar code reader.

17. The display system of claim 13, wherein said indicia-bearing tag comprises alphanumeric text, and wherein said indicia reader comprises an alphanumeric text scanner.

18. The display system of claim 13, wherein said interactive display further comprises:
a substantially flat platform for supporting the object, said platform being supported substantially horizontally on said housing.

19. The display system of claim 13, wherein said interactive display further comprises:
a mirror for providing a reflected image of the object, said mirror being supported on said housing in a substantially vertical position adjacent said platform.

20. The display system of claim 13, wherein said interactive display further comprises:
a lighting fixture mounted on said housing in position to direct light downwardly onto said platform, said lighting fixture being configured to change from an extinguished state to an illuminated state responsive entry of an indicia-bearing tag into the zone.

21. The display system of claim 13, wherein said interactive display and said rack are physically disposed within a single building.

22. A method for providing an interactive display of information relating to a physical object system, the method comprising:
providing an interactive display comprising:
a housing;
a display device supported on said housing;
an indicia reader supported on said housing, said indicia reader being configured to read an indicia-bearing tag when positioned within a zone adjacent the housing;
a computerized system configured to receive object identification information from said indicia reader when said indicia-bearing tag is positioned within the zone and to provide related object information; said computerized system comprising:
a microprocessor;
a memory operably connected to said microprocessor; and
related object information stored in said memory, the related object information being stored in said memory in association with the object identification information; and
receiving identification information from an indicia-bearing tag positioned within the zone;
retrieving from said memory related object information;
presenting related object information to a user via the display device while the indicia-bearing tag remains within the zone; and
ceasing to present related object information to the user via the display device when the indicia-bearing tag is no longer within the zone.

23. The method of claim 22, wherein the interactive display further comprises a lighting fixture mounted on the housing, the method further comprising:
illuminating the lighting fixture responsive to receiving identification information from an indicia-bearing tag positioned within the zone.
